(19) United States
(12) Patent Application Publication
(10) Pub. No.: US 2011/0133531 A1
(43) Pub. Date: Jun. 9, 2011

(54) SEAT APPLICABLE TO VEHICLES

(76) Inventor: Chia-Chang YEH, Taibao City (TW)

(21) Appl. No.: 12/634,010

(22) Filed: Dec. 9, 2009

(51) Int. Cl. B60N 2/00; B60N 2/68; B60N 2/22; B60N 2/06; B60N 2/44; B60N 2/005

(52) U.S. Cl. 297/232; 297/452.46; 297/452.18; 297/354.12; 297/344.1; 297/452.11

(57) ABSTRACT

A seat applicable to vehicles comprises a seatback unit and the chair base unit. The seatback unit comprises a first frame and a first net support portion. The first frame fixes and pushes open the first net support portion. The first net support portion has many thru holes. The chair base unit is combined with the seatback unit. The chair base unit comprises a second frame and a second net support portion. The second frame fixes and pushes open the second net support portion. The second net support portion has many thru holes. The seatback unit and the chair base unit are supported by the first and second net support portions, so the rider comfort ability and the chair ventilation ability significantly increases. The structure of seat is simple, so the weight of seat significantly decreases and light, making the vehicle consume less fuel.

### BACKGROUND OF THE INVENTION

1. Field of the Invention

This invention relates to a seat applicable to vehicles.

2. Description of the Related Art

With reference to FIGS. 1 and 2 respectively shown as a 3D view of a conventional assembled seat, and a partially sectional view of the seat, the seat 1 comprises a seatback 2, a chair base 3, an adjustment unit 4, and a sliding unit 5. The adjustment unit 4 is used to combine the seatback 2 with the chair base 3. Further, the sliding unit 5 is provided below the chair base 3. The sliding unit 5 may be fixed onto a vehicle (not shown). Next, foam sponge used as a filler is filled in the seatback 2 and the chair base 3, and the seatback 2 and the seat 3 are covered and formed with a leather (or a cloth) 7, as shown in FIG. 2 illustrating a portion of the seatback 2.

Although the seat 1 is provided with the feature of softness and comfort during riding, because the foam sponge 6 is wrapped with the leather and cloth 7, the quality of ventilation is poor. Next, the temperature of leather and cloth 7 cannot be constant. Further, the seat 1 is structured with quite many members, so the weight of the whole structured seat increases, and thus when it is loaded in the vehicle, the vehicle bears a heavy burden and consumes more fuel. Thus, improvement of the conventional seat is necessarily made.

Consequently, because of the technical defects of described above, the applicant keeps on carving unflaggingly through wholehearted experience and research to develop the present invention, which can effectively improve the defects described above.

### SUMMARY OF THE INVENTION

A seat applicable to and arranged in vehicles mainly comprises a seatback unit and a chair base unit. The seatback unit is provided with a first frame and a first net support portion. The first frame is combined with and fixed to the first net support portion. The first net support portion is pushed open by the first frame. Further, the first net support portion has a plurality of thru holes. The chair base unit combined with the seatback unit. The chair base unit comprises a second frame and a second net support portion. The second frame is combined with and fixed to the second net support portion. The second net support portion is pushed open by the second frame. Further, the second net support portion has a plurality of thru holes.

Thus, the seatback unit and the chair base unit are supported by the first and second net support portions for a rider to sit and lie on, so the rider comfort ability and the chair ventilation ability may significantly increase. Further, the structure of seat according to this invention is simple, so the weight of seat significantly decreases and thus light, which makes the vehicle consume less fuel.

### BRIEF DESCRIPTION OF THE DRAWINGS

FIG. 1 is a 3D view of a conventional assembled seat;

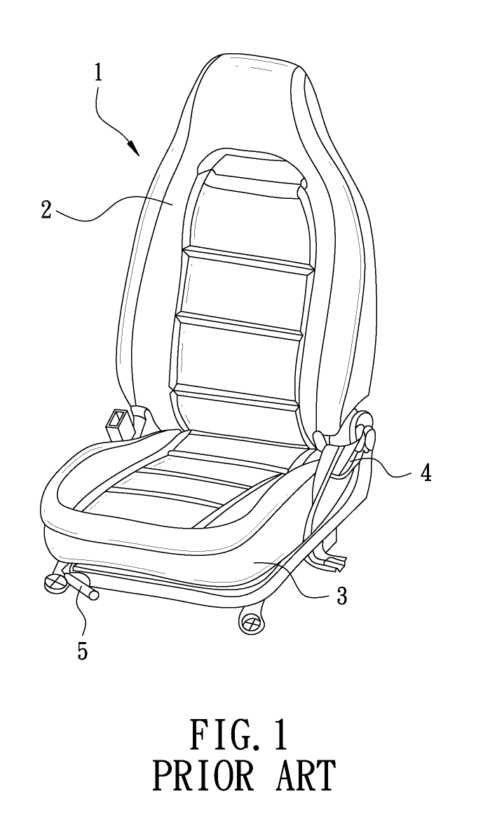

FIG. 2 is a partially sectional view of the conventional seat;

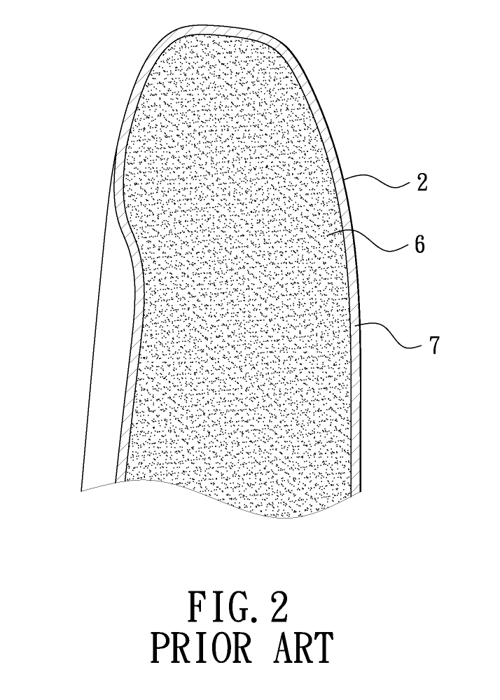

FIG. 3 is a 3D assembly view of a first embodiment of this invention;

FIG. 4 is a 3D exploded view of a seatback unit in the first embodiment of this invention;

FIG. 5 is a 3D exploded view of a chair base unit in the first embodiment of this invention;

FIG. 6 is a 3D view of a second embodiment of this invention; and

FIG. 7 is a schematic view illustrating the operation of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

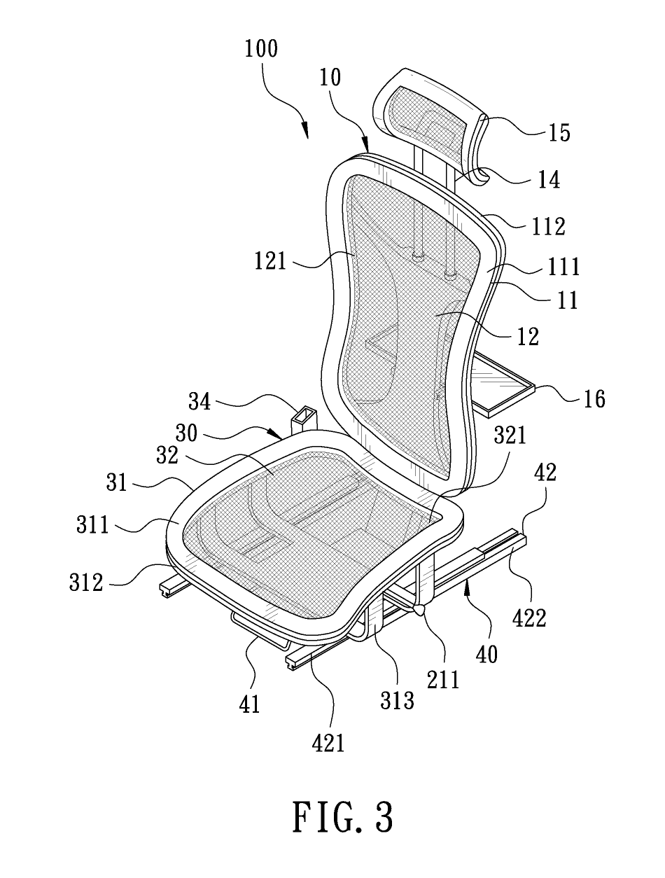

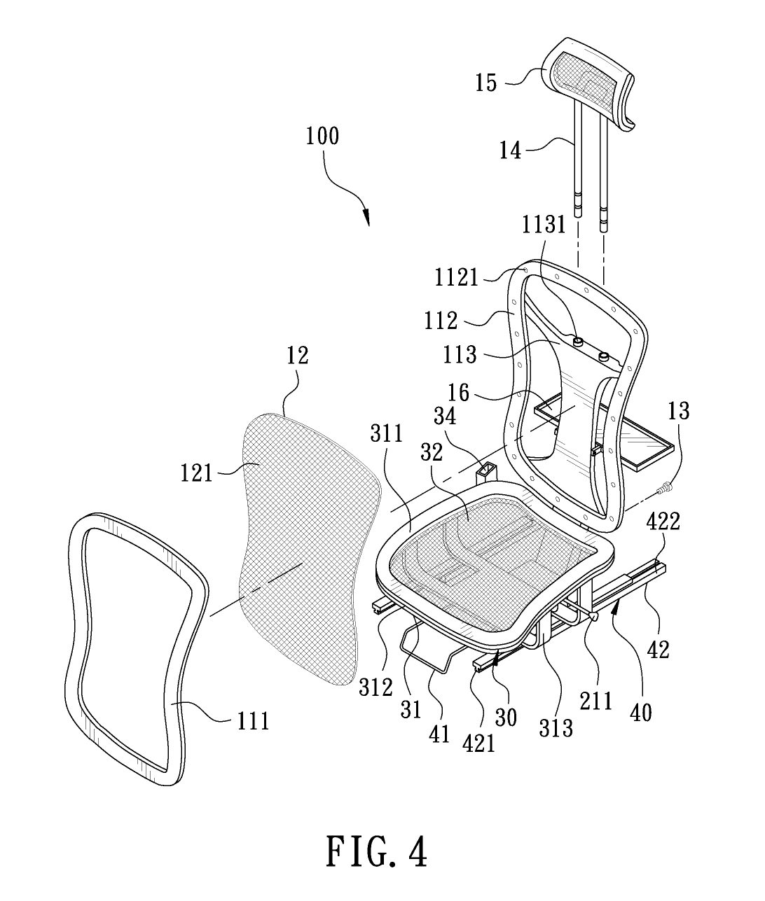

Firstly, with reference to FIGS. 3 and 4 shown respectively as a 3D assembly view of a first embodiment of this invention and as a 3D exploded view of a seatback unit, the seat 100 comprises a seatback unit 10, an adjustment unit 20, a chair base unit 30, and a shifting unit 40.

The seatback unit 10 comprises a first frame 11 and a first net support portion 12. The first frame 11 further comprises a first front frame 111 and a first rear frame 112. The first front frame 111 and the first rear frame 112 are looped, and the first net support portion 12 is clipped and fixed between the first front frame 111 and the first rear frame 112. Further, the first net support portion 12 has a plurality of thru holes 121. Next, the first net support portion 12 is pushed open by the first front frame 111 and the first rear frame 112. The first rear frame 112 is provided with a plurality of screw holes 1121. Next, a plurality of first fixing units 13 are used to pass through the screw holes 1121 for making the first rear frame 112 connect to the first front frame 111 and the first net support portion 12. In a preferred embodiment of this invention, the first fixing unit 13 is a screw and the first net support portion 12 is a mesh. Further, the first rear frame 112 stretches towards the center and is then formed with a combination mount 113. Two insertion holes 1131 are formed on the combination mount 113. Two wedge pillars 14 are wedged into the insertion holes 1131. The wedge pillars 14 aligns to the insertion holes 1131, and a headrest 15 is connected to the other sides of the pillars 14. Next, the combination mount 113 is connected to a glove plate 16 where objects as beverage or food may be placed.

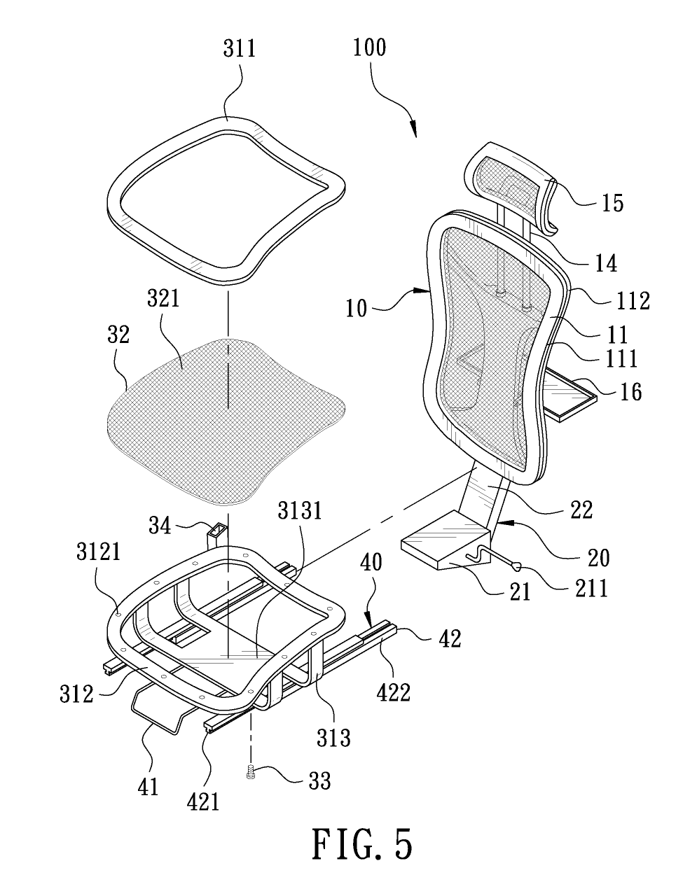

With reference to FIG. 5 as a 3D exploded view of a chair base unit in the first embodiment of this invention, the adjustment unit 20 is fixed to the seatback unit 10. The adjustment unit 20 comprises a seat adjustment part 21 and a connection part 22. The seat adjustment part 21 is provided with an inclined adjustment handle 211. The inclined adjustment handle 211 stretches from a side of the seat adjustment part 21. Further, the seat adjustment part 21 stretches from a side of the seatback unit 10 and is provided with the connection part 22. The connection part 22 is connected and fixed to the combination mount 113 of the first rear frame 112.

The chair base unit 30 is combined with the seatback unit 10 by means of the adjustment unit 20. The chair base unit 30 comprises a second frame 31 and a second net support portion 32. The second frame 31 further comprises a second upper frame 311 and a second lower frame 312. The second upper frame 311 and the second lower frame 312 are looped, and second net support portion 32 is clipped and fixed between the second upper frame 311 and the second lower frame 312. Further, the second net support portion 32 has a plurality of thru holes 321. Next, the second net support portion 32 is pushed open by the second upper frame 311 and the second lower frame 312. The second lower frame 312 is provided with a plurality of screw holes 3121. Next, a plurality of second fixing units 33 are used to pass through the screw holes 3121 for making the second lower frame 312 connect to the second upper frame 311 and the second net support portion 32. In a preferred embodiment of this invention, the second fixing unit 33 is a screw and the second net support portion 32 is a mesh. Further, the second lower frame 312 stretches downwards and is provided with a joint 313. The center of joint 313 is formed with a joint plate 3131. The seat adjustment part 21 is fixed to the bottom side of joint plate 3131. Next, a side of the second lower frame 312 is formed with a safety belt mount 34.

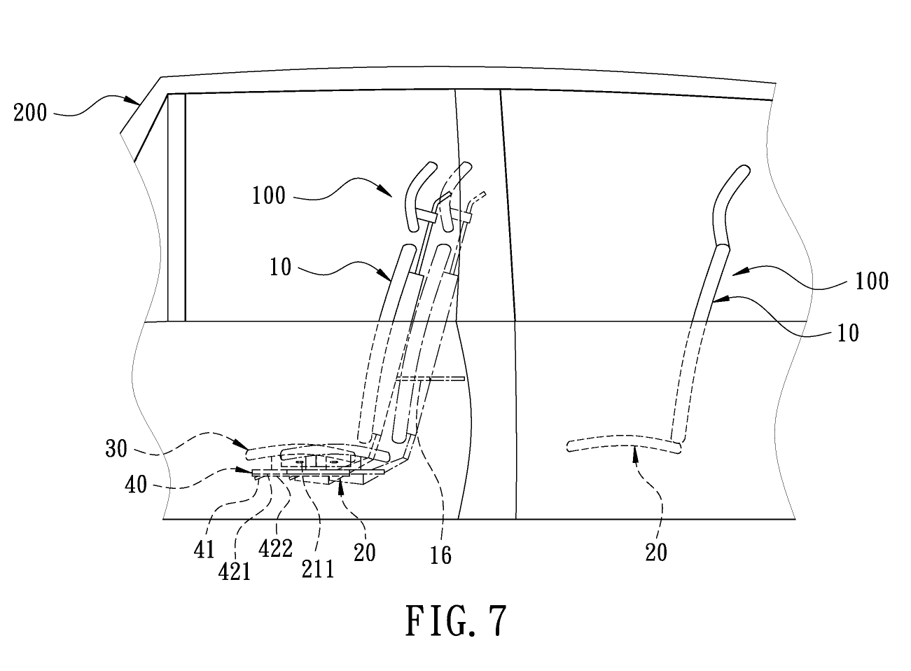

The shifting unit 40 is provided below the chair base unit 30 and comprises a shifting adjustment rod 41 and a slide rail pair 42. The shifting adjustment rod 41 is wedged to the slide rail pair 42. The slide rail 42 comprises a male slide rail 421 and a female slide rail 422. The mail slide rail 421 is fixed to the joint 313 of second lower frame 312, while the female slide rail 422 may be fixed to the vehicle 200, as shown in FIG. 7.

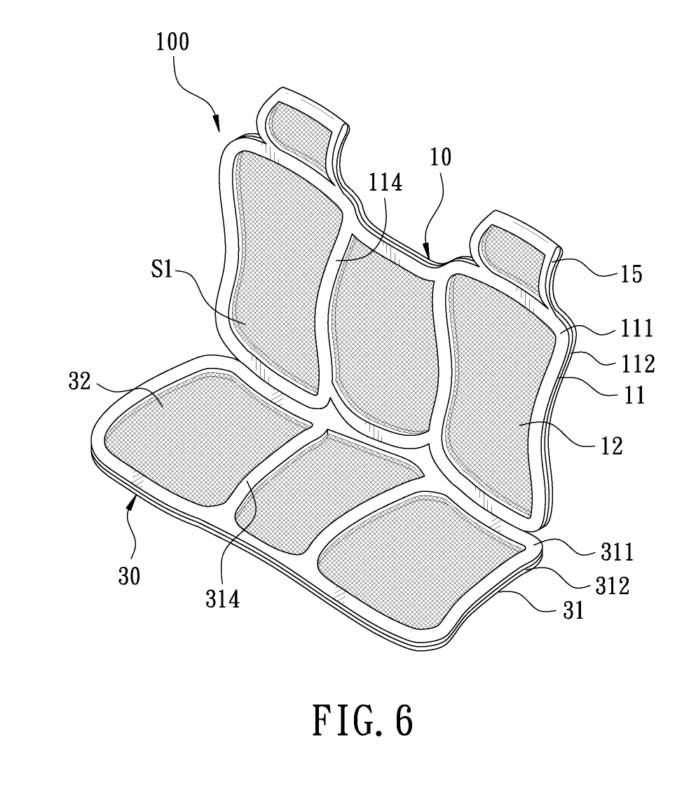

With reference to FIG. 6 as a 3D view of a second embodiment almost same as the first embodiment; what is mainly different is the seatback unit 10 fixed to and combined with the chair base unit 30 below which a connection unit (not shown) is provided and thus fixed onto the vehicle 200, as shown in FIG. 7. And the seatback unit 10 and the chair base unit 30 are designed for a space where 3 persons may occupy. The first frame 11 and second frame 31 for the seatback unit 10 and chair base unit 30 are designed all in one. The middle sections of the first and second frames 11 and 31 are spaced respectively into two first compartment ribs 114 and two second compartment ribs 14. The first and second compartment ribs 114 and 314 commonly compart the seatback unit 10 and the chair base unit 30 into 3 ride spaces S1. Besides, the two sides of first frame 11 wholly stretch to connect to two headrests 15.

With reference to FIG. 7 as a schematic view illustrating the operation of this invention, the slide rail pair 42 or the joint unit may be used to fix the seat 100 according to this invention onto the vehicle 200. In the embodiment of this invention, the vehicle 200 is, for example, a car. The slide rail pair 42 is used to connect and fix a front seat in the vehicle 200 to the seat 100 according to this invention so that a user may pull the shifting adjustment rod 41 to slide the seat 100 along the male and female slide rails 421 and 422. Further, the inclined adjustment handle 211 may be pulled to make the connection part 22 synchronously drive the seatback unit 10 to shift and tilt backward or forward. The joint unit is used to connect and fix a rear seat in the vehicle 200 to the seat 100 according to this invention. Next, the seatback unit 10 and the chair base unit 30 are supported by the first and second net support portions 12 and 32 for a rider to sit and lie on, so the rider comfort ability and the ventilation ability of seat 100 may significantly increase. The temperature of the first and second net support portions 12 and 32 may be constant. Further, the structure of seat 100 according to this invention is simple, so the weight of seat significantly decreases and thus light, which makes the vehicle 200 consume less fuel.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A seat applicable to vehicles, being provided on a vehicle and mainly comprising:
at least one seatback unit, comprising a first frame and a first net support portion, in which the first frame is combined with and fixed to the first net support portion, the first net support portion is pushed open by the first frame, and the first net support portion has a plurality of thru holes; and
at least one chair base unit, being combined with the seatback unit and comprising a second frame and a second net support portion, in which the second frame is combined with and fixed to the second net support portion, the second net support portion is pushed open by the second frame, and the second net support portion has a plurality of thru holes.

2. The seat applicable to vehicles according to claim 1, wherein the first frame further comprises a first front frame and a first rear frame, the first front frame is connected to the first rear frame, the first net support portion is clipped and fixed between the first front frame and the first rear frame, a plurality of first fixing units are used to combine the first front frame, the first rear frame, and the first net support portion, the second frame also comprises a second upper frame and a second lower frame, the second upper frame is connected to the second lower frame, the second net support portion is clipped and fixed between the second upper frame and the second lower frame, and a plurality of second fixing units are used to combine the second upper frame, the second lower frame, and the second net support portion.

3. The seat applicable to vehicles according to claim 2, wherein the first and second fixing units are screws.

4. The seat applicable to vehicles according to claim 1, wherein an adjustment unit is fixed between the seatback unit and the chair base unit.

5. The seat applicable to vehicles according to claim 4, wherein the adjustment unit comprises a seat adjustment part and a connection part, the seat adjustment part is combined with and fixed to the second frame of chair base unit, the seat adjustment part is provided with an inclined adjustment handle, the seat adjustment part stretches from a side of the seatback unit and is provided with the connection part, the connection part is combined with and fixed to the first frame of the seatback unit.

6. The seat applicable to vehicles according to claim 5, wherein the second frame stretches towards a side and is provided with a joint and the joint is connected to the seat adjustment part.

7. The seat applicable to vehicles according to claim 1, wherein a side of the chair base unit is formed with a safety belt mount.

8. The seat applicable to vehicles according to claim 1, wherein a shifting unit is provided below the chair base unit and comprises a shifting adjustment rod and a slide rail pair, and the shifting adjustment rod is wedged to the slide rail pair.

9. The seat applicable to vehicles according to claim 1, wherein the seatback unit is fixed to and combined with the chair base unit in one.

10. The seat applicable to vehicles according to claim 9, wherein the middle sections of the first and second frames are spaced respectively into at least one first compartment rib and at least one second compartment rib, and the first and second compartment ribs compart the seatback unit and the chair base unit into a plurality of ride spaces.

11. The seat applicable to vehicles according to claim 1, wherein the first and second net support portion are meshes.
